(19) United States
(12) Patent Application Publication
(10) Pub. No.: US 2018/0352452 A1
(43) Pub. Date: Dec. 6, 2018

(54) SYSTEM AND METHOD FOR TESTING A WIRELESS COMMUNICATION DEVICE

(71) Applicant: HCL Technologies Limited, Noida (IN)

(72) Inventor: Vijay Tiruchengode PARTHASARATHY, Chennai (IN)

(21) Appl. No.: 15/995,147

(22) Filed: Jun. 1, 2018

(30) Foreign Application Priority Data
Jun. 3, 2017 (IN) 201711019532

(51) Int. Cl. H04W 24/06; B64C 39/02; G08G 5/00; H04W 4/80

(52) U.S. Cl. CPC H04W 24/06; H04W 4/80; G08G 5/0004; B64C 39/024

(57) ABSTRACT

The present disclosure relates to system(s) and method(s) for testing a wireless communication device installed over an Unmanned Arial Vehicle (UAV) is illustrated. The method may comprise transmitting navigation data to an Unmanned Arial Vehicle (UAV). The method may further comprise transmitting one or more test packets, to a wireless communication device installed over the UAV when the UAV is in the vicinity of the second location. The set of test packets may be transmitted via a short range communication channel. The method may further comprise receiving one or more response data packets from the wireless communication device via a cloud communication channel. The method may further comprise generating a test report based on comparison of the one or more response data packets with the one or more test packets.

### CROSS-REFERENCE TO RELATED APPLICATIONS AND PRIORITY

This present application claims benefit from Indian Complete Patent Application No. 201711019532 filed on 3 Jun. 2017, the entirety of which is hereby incorporated by reference.

### TECHNICAL FIELD

The present disclosure in general relates to the field of testing. More particularly, the present invention relates to a system and method for connectivity, signal strength, and range testing of wireless communication devices.

### BACKGROUND

Nowadays, with the growth in electronics and telecommunication sector, users of wireless communication devices have increased exponentially. The interconnectivity of these devices is through internet. Internet access is enabled through short range communication channels or long range communication channels. Generally, an electronic device is enabled with both short range and long range communication capabilities. These devices connect with cellular towers, Wi-Fi routers, or NFC devices to connect with rest of the world.

The wireless communication devices/Radio devices are majorly used for data transfer between devices wirelessly. The wireless communication devices like AM, FM, Wi-Fi, Bluetooth, Zigbee, NFC, are utilized in vertical like Medical, Aero, Auto, Consumer, and alike. The application of these devices include wireless file sharing, video tethering, V2V, M2M communication, IOT, and alike.

Mostly the wireless communication devices are tested manually for RF range, anti-collision, and signal strength which increases cost and time to market. Furthermore, by using manual testing, it becomes very difficult to test a wireless communication device in a closed environment such as an apartment, a row house, and a like.

### SUMMARY

This summary is provided to introduce aspects related to a system and method for testing a wireless communication device and the aspects are further described below in the detailed description. This summary is not intended to identify essential features of the claimed subject matter nor is it intended for use in determining or limiting the scope of the claimed subject matter.

In one embodiment, a method for testing a wireless communication device installed over an Unmanned Arial Vehicle (UAV) is illustrated. The method may comprise transmitting, by a processor, navigation data to an Unmanned Arial Vehicle (UAV). The navigation data comprises instructions for traveling from first location to at least one second location from a set of locations with an indoor environment. The method may further comprise transmitting, by the processor, one or more test packets, to a wireless communication device installed over the UAV when the UAV is in the vicinity of the second location. The set of test packets may be transmitted via a short range communication channel. The method may further comprise receiving, by the processor, one or more response data packets from the wireless communication device via a cloud communication channel. The one or more response data packets are transmitted by the wireless communication device via the cloud communication channel based on receiving of the one or more test packets. The method may further comprise generating, by the processor, a test report based on comparison of the one or more response data packets with the one or more test packets.

In another embodiment, a system for testing a wireless communication device installed over an Unmanned Arial Vehicle (UAV) is illustrated. The system comprises a memory and a processor coupled to the memory, further the processor may be configured to execute programmed instructions stored in the memory. In one embodiment, the processor may execute programmed instructions stored in the memory for transmitting navigation data to an Unmanned Arial Vehicle (UAV). The navigation data comprises instructions for traveling from first location to at least one second location from a set of locations with an indoor environment. The processor may further execute programmed instructions stored in the memory for transmitting one or more test packets, to a wireless communication device installed over the UAV when the UAV is in the vicinity of the second location. The set of test packets may be transmitted via a short range communication channel. The processor may further execute programmed instructions stored in the memory for receiving one or more response data packets from the wireless communication device via a cloud communication channel. The one or more response data packets are transmitted by the wireless communication device via the cloud communication channel based on receiving of the one or more test packets. The processor may further execute programmed instructions stored in the memory for generating a test report based on comparison of the one or more response data packets with the one or more test packets.

In yet another embodiment, a computer program product having embodied computer program for testing a wireless communication device installed over an Unmanned Arial Vehicle (UAV) is disclosed. The program may comprise a program code for transmitting navigation data to an Unmanned Arial Vehicle (UAV). The navigation data comprises instructions for traveling from first location to at least one second location from a set of locations with an indoor environment. The program may comprise a program code for transmitting one or more test packets, to a wireless communication device installed over the UAV when the UAV is in the vicinity of the second location. The set of test packets may be transmitted via a short range communication channel. The program may comprise a program code for receiving one or more response data packets from the wireless communication device via a cloud communication channel. The one or more response data packets are transmitted by the wireless communication device via the cloud communication channel based on receiving of the one or more test packets. The program may comprise a program code for generating a test report based on comparison of the one or more response data packets with the one or more test packets.

### BRIEF DESCRIPTION OF DRAWINGS

The detailed description is described with reference to the accompanying figures. In the figures, the left-most digit(s) of a reference number identifies the figure in which the reference number first appears. The same numbers are used throughout the drawings to refer like features and components.

FIG. 1 illustrates a network implementation of a system for testing a wireless communication device installed over an Unmanned Arial Vehicle (UAV), in accordance with an embodiment of the present subject matter.

FIG. 2 illustrates the system for testing the wireless communication device, in accordance with an embodiment of the present subject matter.

FIG. 3 illustrates a method for testing the wireless communication device, in accordance with an embodiment of the present subject matter.

FIG. 4A illustrate a block diagram of one to one communication between the system and UAV, in accordance with an embodiment of the present subject matter.

FIG. 4B illustrate a block diagram of one to many communication channels established between the system and UAV's, in accordance with an embodiment of the present subject matter.

FIG. 5A illustrate a block diagram of many to one communication channel established between the wireless communication devices installed over a single UAV and the system, in accordance with an embodiment of the present subject matter.

FIG. 5B illustrate block diagram of the system configured for testing a V2V network of wireless communication devices installed over the UAV's, in accordance with an embodiment of the present subject matter.

### DETAILED DESCRIPTION

Some embodiments of the present disclosure, illustrating all its features, will now be discussed in detail. The words “transmitting”, “receiving”, “generating”, and other forms thereof, are intended to be equivalent in meaning and be open ended in that an item or items following any one of these words is not meant to be an exhaustive listing of such item or items, or meant to be limited to only the listed item or items. It must also be noted that as used herein and in the appended claims, the singular forms “a,” “an,” and “the” include plural references unless the context clearly dictates otherwise.

Various modifications to the embodiment will be readily apparent to those skilled in the art and the generic principles herein may be applied to other embodiments. However, one of ordinary skill in the art will readily recognize that the present disclosure for testing a wireless communication device installed over an Unmanned Arial Vehicle (UAV) is not intended to be limited to the embodiments illustrated, but is to be accorded the widest scope consistent with the principles and features described herein.

The present subject matter relates to a system and method for testing the wireless communication device installed over the Unmanned Arial Vehicle (UAV). The system enables automation testing of the wireless communication devices at product development stage. The system may be used in the RFID technology for testing LF, HP, VHF including anti-collision testing and range testing. The range testing, Receiver Signal Strength Indicator (RSSI) may be enabled by controlling the distance between the UAV and the test PC/system. In one embodiment, an automation testing framework is enabled over a Test PC hereafter referred to as the system. The system is configured to communicate with the wireless communication device and the UAV using short range communication channel. The wireless communication device may be selected from a radio frequency based communication device such as AM, FM, LF, HF, or BT. The system is also configured to maintain a configuration file containing the details of the wireless communication device to be tested and the UAV on which the wireless communication device is mounted. The system may also store a data file to be used for testing the wireless communication device. The system and the wireless device may further be connected to a cloud platform via a long range communication channel In another embodiment, the data file and test report generated after testing the wireless communication device may be maintained at the cloud server.

In one embodiment, the system is configured to communicate with the UAV, the cloud platform, the wireless communication device under test via short range communication and long range communication. The configuration file, test script, RF data analyser, report generator algorithm may be enabled over the system. In one embodiment, the UAV is enabled with GPS capabilities and is configured to navigate in a closed environment such as a warehouse, office, factory, house, and alike. In one embodiment, the system is configured to read a configuration file and send the navigation data/GPS location coordinates in the closed environment, where the UAV should reach before initiating the process of range testing. The GPS location coordinates depending upon the range of the wireless communication device/RF device.

Once the UAV reaches the GPS location coordinates specified by the system, the system is configured to transmit one or more test packets from the data file to the wireless communication device mounted over the UAV. In one embodiment, the test packets may correspond to a data file, audio, or video file. Upon receipt of the one or more test packets, the wireless communication device is configured to generate one or more response data packets with the data received from the system and upload the one or more response data packets to the cloud platform via long range communication channel. The system may then fetch the one or more response data packets from the cloud platform and compare the one or more response data packets with the corresponding one or more test packets transmitted to the wireless communication device in order to determine connectivity, range and signal strength of the wireless communication device and generate test report for the wireless communication device enabled over the UAV. In another implementation, the test packets may be transmitted from the system to the wireless communication device via long range communication channel/cloud communication channel and the response data packets may be received via short range communication channel. In either of the cases, the one or more test packets are compared with the corresponding response data packets to verify data integrity, speed of transmission and other parameters associated with the wireless communication device.

In another embodiment, the system may be enabled over a UAV for testing V2V communication in the automobile field. For this purpose, the wireless communication devices/transceiver devices can be fitted in multiple drones, for testing applications like collision detection testing, active safety system, and a like.

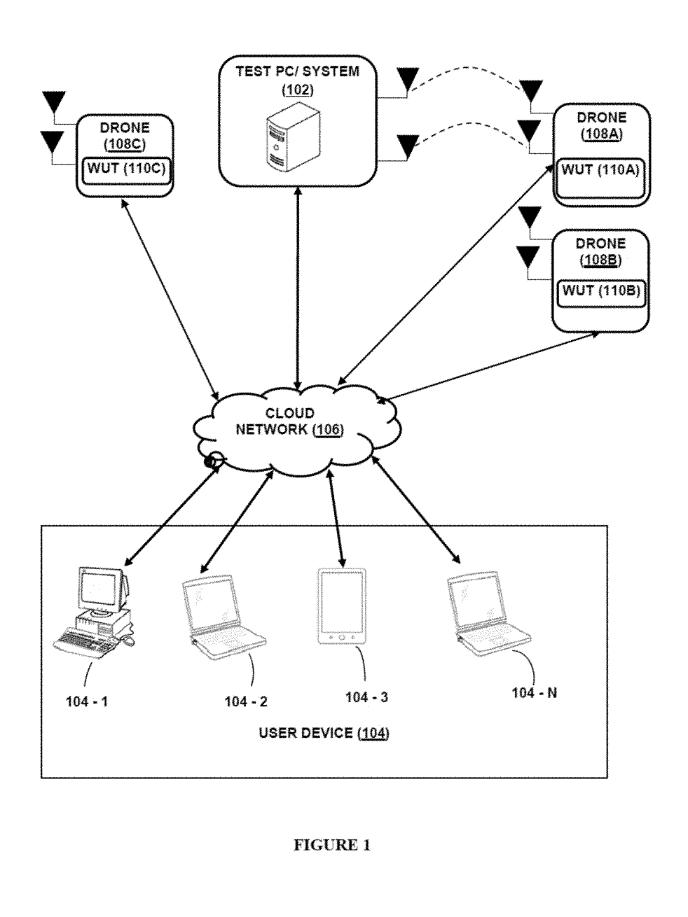

Referring now to FIG. 1, a network implementation 100 of a system 102 for wireless communication device installed over an Unmanned Arial Vehicle (UAV) is disclosed. Although the present subject matter is explained considering that the system 102 is implemented on a server, it may be understood that the system 102 may also be implemented in a variety of computing systems, such as a laptop computer, a desktop computer, a notebook, a workstation, a mainframe computer, a server, a network server, and the like. In one implementation, the system 102 may be implemented in a cloud-based environment. It will be understood that the system 102 may be accessed by multiple users through one or more user devices 104-1, 104-2 . . . 104-N, collectively referred to as user device 104 hereinafter, or applications residing on the user device 104. Examples of the user device 104 may include, but are not limited to, a portable computer, a personal digital assistant, a handheld device, and a workstation. The user device 104 may be communicatively coupled to the system 102 through a cloud network 106. Further, the system 102 may be communicatively coupled with the one or more UAV's 108 through a short range communication channel and a cloud communication channel. The UAV's 108 may be enabled with a wireless communication device. The wireless communication device may comprise wireless transmitters and receivers for short range and long range communication.

In one implementation, the network 106 may be a wireless network, a wired network or a combination thereof. The network 106 may be implemented as one of the different types of networks, such as intranet, local area network (LAN), wide area network (WAN), the internet, and the like. The network 106 may either be a dedicated network or a shared network. The shared network represents an association of the different types of networks that use a variety of protocols, for example, Hypertext Transfer Protocol (HTTP), Transmission Control Protocol/Internet Protocol (TCP/IP), Wireless Application Protocol (WAP), and the like, to communicate with one another. Further, the network 106 may include a variety of network devices, including routers, bridges, servers, computing devices, storage devices, and the like.

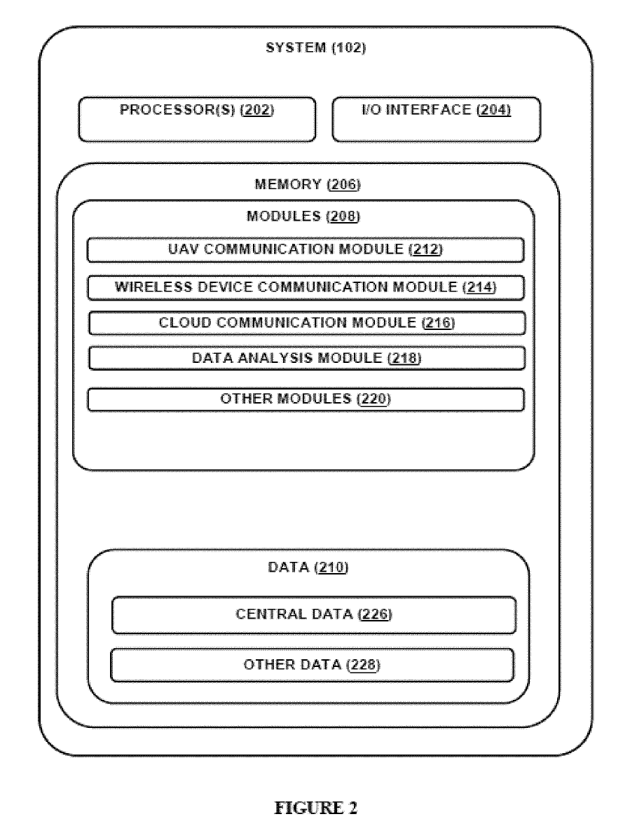

In one embodiment, the method for testing a wireless communication device installed over an Unmanned Arial Vehicle (UAV) may comprise transmitting navigation data to an Unmanned Arial Vehicle (UAV). The navigation data comprises instructions for traveling from first location to at least one second location from a set of locations with an indoor environment. The method may further comprise transmitting one or more test packets, to a wireless communication device installed over the UAV when the UAV is in the vicinity of the second location. The set of test packets may be transmitted via a short range communication channel. The method may further comprise receiving one or more response data packets from the wireless communication device via a cloud communication channel. The one or more response data packets are transmitted by the wireless communication device via the cloud communication channel based on receiving of the one or more test packets. The method may further comprise generating a test report based on comparison of the one or more response data packets with the one or more test packets for testing the wireless communication device. The system 102 for testing the wireless communication device is further elaborated with respect to the FIG. 2.

Referring now to FIG. 2, the system 102 for testing the wireless communication device installed over the Unmanned Arial Vehicle (UAV) is illustrated in accordance with an embodiment of the present subject matter. In one embodiment, the system 102 may be configured to communicate with the UAV 108 and a wireless communication device/wireless device under test (WUT) 110 installed over the UAV 108. The system 102 may include at least one processor 202, an input/output (I/O) interface 204, and a memory 206. The at least one processor 202 may be implemented as one or more microprocessors, microcomputers, microcontrollers, digital signal processors, central processing units, state machines, logic circuitries, and/or any devices that manipulate signals based on operational instructions. Among other capabilities, at least one processor 202 may be configured to fetch and execute computer-readable instructions stored in the memory 206.

The I/O interface 204 may include a variety of software and hardware interfaces, for example, a web interface, a graphical user interface, and the like. The I/O interface 204 may allow the system 102 to interact with the user directly or through the user device 104. Further, the I/O interface 204 may enable the system 102 to communicate with other computing devices, such as web servers and external data servers (not shown). The I/O interface 204 may facilitate multiple communications within a wide variety of networks and protocol types, including wired networks, for example, LAN, cable, etc., and wireless networks, such as WLAN, cellular, or satellite. The I/O interface 204 may include one or more ports for connecting a number of devices to one another or to another server.

The memory 206 may include any computer-readable medium known in the art including, for example, volatile memory, such as static random access memory (SRAM) and dynamic random access memory (DRAM), and/or non-volatile memory, such as read only memory (ROM), erasable programmable ROM, flash memories, hard disks, optical disks, and magnetic tapes. The memory 206 may include modules 208 and data 210.

The modules 208 may include routines, programs, objects, components, data structures, and the like, which perform particular tasks, functions or implement particular abstract data types. In one implementation, the module 208 may include a UAV communication module 212, a wireless device communication module 214, a cloud communication module 216, a data analysis module 218, and other modules 220. The other modules 220 may include programs or coded instructions that supplement applications and functions of the system 102.

The data 210, amongst other things, serve as a repository for storing data processed, received, and generated by one or more of the modules 208. The data 210 may also include a central data 226, and other data 228. In one embodiment, the other data 228 may include data generated as a result of the execution of one or more modules in the other module 220.

In one implementation, a user may access the system 102 via the I/O interface 204. The user may be registered using the I/O interface 204 in order to use the system 102. In one aspect, the user may access the I/O interface 204 of the system 102 for obtaining information, providing inputs or configuring the system 102.

In one embodiment, the UAV communication module 212 may be configured to transmit navigation data to an Unmanned Arial Vehicle (UAV) via a wireless communication channel. The navigation data comprises instructions for traveling from first location to at least one second location from a set of locations with an indoor environment. In another embodiment, the navigation data may comprise a list of geographical locations within indoor environment. The list of geographical locations may be generated based on the layout information of the indoor environment and a desired wireless range of a wireless communication device 110 mounted over the UAV 108. In one embodiment, upon receipt of the navigation data, the UAV 108 is configured to reach the second location specified in the navigation data. In one embodiment, a reception activation signal for enabling reception of data by the wireless communication device 110 is transmitted to the wireless communication device 110. After receiving the reception activation signal, the wireless communication device 110 is configured send acknowledgement signal to the system 102 and activate a transceiver to receive data from the system 102 via short range communication channel.

In one embodiment, once the UAV 108 reaches the second location, the wireless device communication module 214 is configured to transmit one or more test packets, to the wireless communication device 110 installed over the UAV 108 when the UAV is in the vicinity of the second location. The set of test packets may be transmitted via a short range communication channel. The short range communication channel may be selected from Bluetooth, Wi-Fi, NFC, and alike. Furthermore, the test packets may correspond to a data file, an audio file or a video file present at the cloud platform/network 106.

Furthermore, the cloud communication module 216 is configured to receive one or more response data packets from the wireless communication device 110 via a cloud communication channel/cloud network 106. The one or more response data packets are transmitted by the wireless communication device 110 via the cloud communication channel based on receiving of the one or more test packets. In one embodiment, when no test packets are received at the wireless communication device 110, an error signal is transmitted to the system 102 via the cloud communication channel.

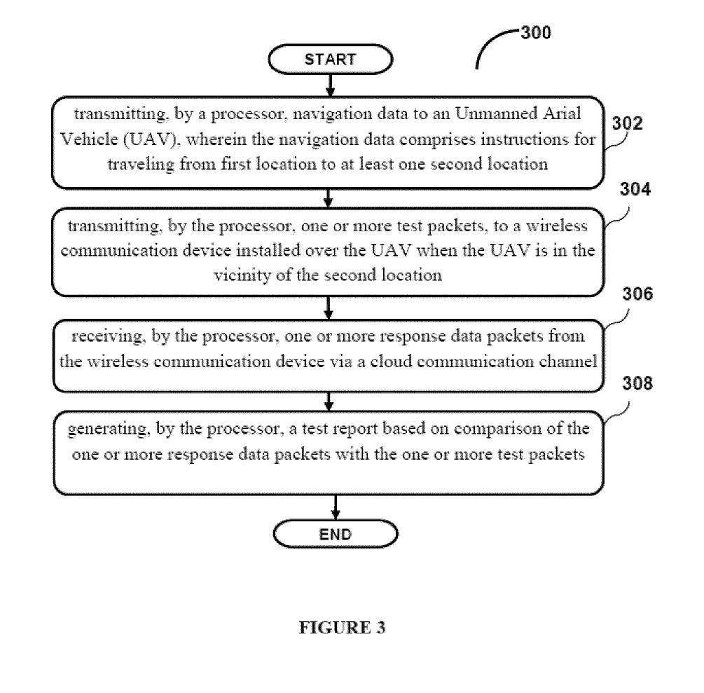

In one embodiment, post receiving the one or more response data packets, the data analysis module 218 is configured to generate a test report based on comparison of the one or more response data packets with the one or more test packets. The test report corresponds to the range testing, collision testing and data integrity testing. By enabling the system 102, a user is able to conduct short range testing and long range testing of wireless communication devices 110 in a single cycle. In one embodiment, a reverse cycle of transmitting data to the wireless communication device 110 through cloud communication channel and receiving data from the wireless communication device 110 through short range communication channel may be enabled for reverse communication testing of the wireless communication device 110. Further, the method testing the wireless communication device installed over the Unmanned Arial Vehicle (UAV) is elaborated with respect to the block diagram of FIG. 3.

Referring now to FIG. 3, a method 300 for testing a wireless communication device installed over an Unmanned Arial Vehicle (UAV), is disclosed in accordance with an embodiment of the present subject matter. The method 300 may be described in the general context of computer executable instructions. Generally, computer executable instructions can include routines, programs, objects, components, data structures, procedures, modules, functions, and the like, that perform particular functions or implement particular abstract data types. The method 300 may also be practiced in a distributed computing environment where functions are performed by remote processing devices that are linked through a communications network. In a distributed computing environment, computer executable instructions may be located in both local and remote computer storage media, including memory storage devices.

The order in which the method 300 is described is not intended to be construed as a limitation, and any number of the described method blocks can be combined in any order to implement the method 300 or alternate methods. Additionally, individual blocks may be deleted from the method 300 without departing from the spirit and scope of the subject matter described herein. Furthermore, the method 300 can be implemented in any suitable hardware, software, firmware, or combination thereof. However, for ease of explanation, in the embodiments described below, the method 300 may be considered to be implemented in the above described system 102.

At block 302, the UAV communication module 212 may be configured to transmit navigation data to the Unmanned Arial Vehicle (UAV) via a wireless communication channel. The navigation data comprises instructions for traveling from first location to at least one second location from a set of locations with an indoor environment. In another embodiment, the navigation data may comprise a list of geographical locations within indoor environment. The list of geographical locations may be generated based on the layout information of the indoor environment and a desired wireless range of a wireless communication device 110 mounted over the UAV 108. In one embodiment, upon receipt of the navigation data, the UAV 108 is configured to reach the second location specified in the navigation data. In one embodiment, a reception activation signal for enabling reception of data by the wireless communication device 110 is transmitted to the wireless communication device 110. After receiving the reception activation signal, the wireless communication device 110 is configured send acknowledgement signal to the system 102 and activate a transceiver to receive data from the system 102 via short range communication channel.

At block 304, once the UAV 108 reaches the second location, the wireless device communication module 214 is configured to transmit one or more test packets, to the wireless communication device 110 installed over the UAV 108 when the UAV is in the vicinity of the second location. The set of test packets may be transmitted via a short range communication channel. The short range communication channel may be selected from Bluetooth, Wi-Fi, NFC, and alike. Furthermore, the test packets may correspond to a data file, an audio file or a video file present at the cloud platform/network 106.

At block 306, the cloud communication module 216 is configured to receive one or more response data packets from the wireless communication device 110 via a cloud communication channel/cloud network 106. The one or more response data packets are transmitted by the wireless communication device 110 via the cloud communication channel based on receiving of the one or more test packets. In one embodiment, when no test packets are received at the wireless communication device 110, an error signal is transmitted to the system 102 via the cloud communication channel.

At block 308, post receiving the one or more response data packets, the data analysis module 218 is configured to generate a test report based on comparison of the one or more response data packets with the one or more test packets. The test report corresponds to the range testing, collision testing and data integrity testing. By enabling the system 102, a user is able to conduct short range testing and long range testing of wireless communication devices 110 in a single cycle.

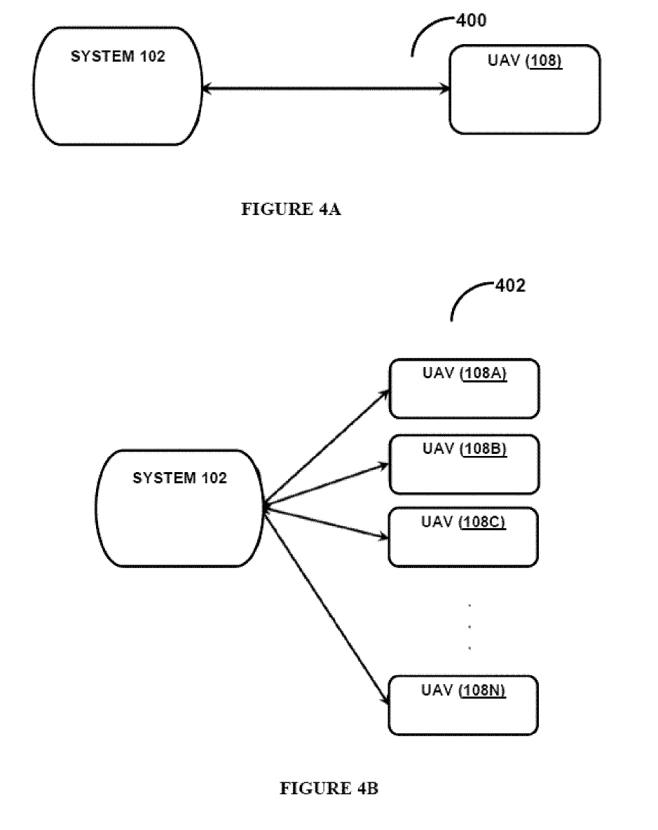

Referring now to FIG. 4A, a block diagram of one to one communication between the system 102 and UAV 108 for testing a wireless communication device installed over an Unmanned Arial Vehicle (UAV), is disclosed in accordance with an embodiment of the present subject matter.

Referring now to FIG. 4B, a block diagram of one to many communication channel established between the system 102 and UAV's 108 for testing more than one wireless communication devices installed over multiple UAV's 108 for reception of test packets, is disclosed in accordance with an embodiment of the present subject matter.

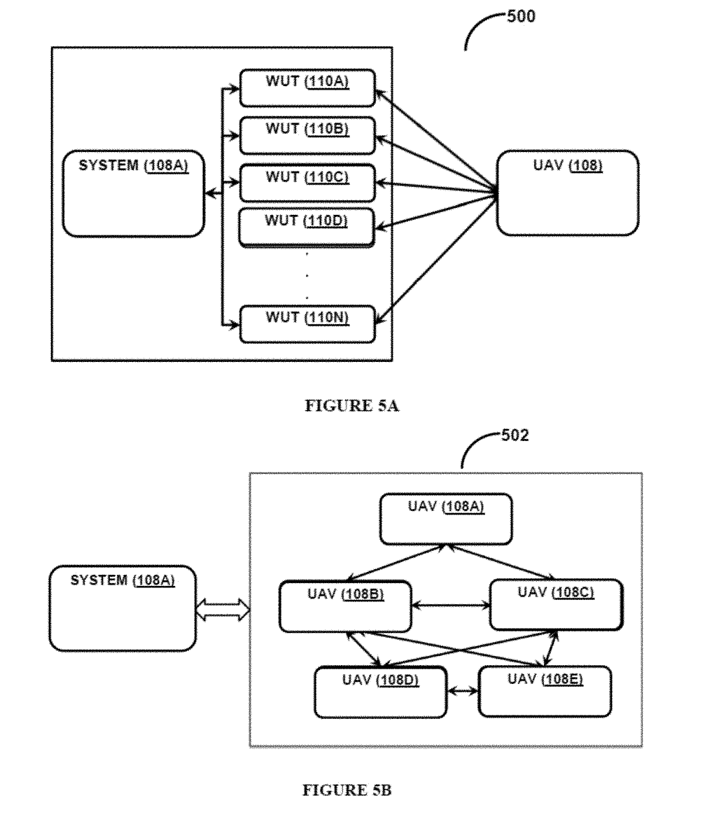

Referring now to FIG. 5A, a block diagram of many to one communication channel established between the wireless communication devices installed over a single UAV 108 and the system 102 for testing wireless communication devices installed over the UAV 108, is disclosed in accordance with an embodiment of the present subject matter.

Referring now to FIG. 5B, a block diagram of the system 102 configured for testing a V2V network of wireless communication devices installed over the UAV's 108 is illustrated.

Although implementations for systems and methods for testing wireless communication device have been described, it is to be understood that the appended claims are not necessarily limited to the specific features or methods described. Rather, the specific features and methods are disclosed as examples of implementations for testing wireless communication device.

We claim:

1. A method for testing a wireless communication device installed over an Unmanned Arial Vehicle (UAV), the method comprising:
transmitting, by a processor, navigation data to an Unmanned Arial Vehicle (UAV), wherein the navigation data comprises instructions for traveling from first location to at least one second location from a set of locations with an indoor environment;
transmitting, by the processor, one or more test packets, to a wireless communication device installed over the UAV when the UAV is in the vicinity of the second location, wherein the set of test packets are transmitted via a short range communication channel;
receiving, by the processor, one or more response data packets from the wireless communication device via a cloud communication channel, wherein the one or more response data packets are transmitted by the wireless communication device via the cloud communication channel based on receiving of the one or more test packets; and
generating, by the processor, a test report based on comparison of the one or more response data packets with the one or more test packets, thereby enabling testing of the wireless communication device installed over the UAV.

2. The method of claim 1, wherein the wireless communication device is selected from a radio frequency based communication device including RF devices like AM, FM, LF, HF, and BT.

3. The method of claim 1, wherein the short range communication channel is selected from Bluetooth, Wi-Fi, NFC and ZigBee.

4. The method of claim 1, wherein the cloud communication channel enables receiving one or more response data packets from the wireless communication device at a cloud server, storing the one or more response data packets over the cloud server, and wherein the processor is configured to receive the one or more response data packets stored over the cloud server.

5. A system for testing a wireless communication device installed over an Unmanned Arial Vehicle (UAV), the system comprising:
a memory; and
a processor communicatively coupled to the memory, wherein the processor ins configured to execute one or more instructions stored in the memory for:
transmitting navigation data to an Unmanned Arial Vehicle (UAV), wherein the navigation data comprises instructions for traveling from first location to at least one second location from a set of locations with an indoor environment;
transmitting one or more test packets, to a wireless communication device installed over the UAV when the UAV is in the vicinity of the second location, wherein the set of test packets are transmitted via a short range communication channel;
receiving one or more response data packets from the wireless communication device via a cloud communication channel, wherein the one or more response data packets are transmitted by the wireless communication device via the cloud communication channel based on receiving of the one or more test packets; and
generating a test report based on comparison of the one or more response data packets with the one or more test packets, thereby enabling testing of the wireless communication device installed over the UAV.

6. The system of claim 5, wherein the wireless communication device is selected from a radio frequency based communication device including RF devices like AM, FM, LF, HF, and BT.

7. The system of claim 5, wherein the short range communication channel is selected from Bluetooth, Wi-Fi, and ZigBee.

8. The system of claim 5, wherein the cloud communication channel enables receiving one or more response data packets from the wireless communication device at a cloud server, storing the one or more response data packets over the cloud server, and wherein the processor is configured to receive the one or more response data packets stored over the cloud server.

9. A computer program product having embodied thereon a computer program for testing a wireless communication device installed over an Unmanned Arial Vehicle (UAV), the computer program product comprising:
a program code for transmitting navigation data to an Unmanned Arial Vehicle (UAV), wherein the navigation data comprises instructions for traveling from first location to at least one second location from a set of locations with an indoor environment;
a program code for transmitting one or more test packets, to a wireless communication device installed over the UAV when the UAV is in the vicinity of the second location, wherein the set of test packets are transmitted via a short range communication channel;
a program code for receiving one or more response data packets from the wireless communication device via a cloud communication channel, wherein the one or more response data packets are transmitted by the wireless communication device via the cloud communication channel based on receiving of the one or more test packets; and
a program code for generating a test report based on comparison of the one or more response data packets with the one or more test packets, thereby enabling testing of the wireless communication device installed over the UAV.
